(19) United States
(12) Patent Application Publication
(10) Pub. No.: US 2020/0190611 A1
(43) Pub. Date: Jun. 18, 2020

(54) PRESS-HARDENED WELDED STEEL ALLOY COMPONENT AND METHOD OF MANUFACTURING

(71) Applicant: GM Global Technology Operations LLC, Detroit, MI (US)

(72) Inventors: Qi Lu, Shanghai (CN); Jianfeng Wang, Nanjing (CN); Charles Enloe, Grosse Pointe Woods, MI (US)

(21) Appl. No.: 16/509,006

(22) Filed: Jul. 11, 2019

(30) Foreign Application Priority Data
Dec. 18, 2018 (CN) 201811550023.4

(51) Int. Cl. C21D 8/02; C21D 8/04; C21D 6/00; C22C 38/00; C22C 38/34; C22C 38/38

(52) U.S. Cl. CPC C21D 8/0226; C21D 8/0484; C21D 6/002; C22C 38/38; C21D 6/008; C22C 38/001; C22C 38/34; C21D 6/005

(57) ABSTRACT

A press-hardened automotive component having a first portion formed from a first steel alloy comprising between about 1.0 and 9.0 weight percent Chromium (Cr), between about 0.5 and 2.0 weight percent Silicon (Si), and between about 0.2 and 0.45 weight percent Carbon (C); and second portion formed from a second steel alloy comprising between about 1.0 and 9.0 weight percent Chromium (Cr), between about 0.5 and 2.0 weight percent Silicon (Si), and between about 0.01 and 0.25 weight percent Carbon (C). Each of the first steel alloy and second steel alloy further comprises between greater than 0.0 to about 3.0 weight percent Manganese (Mn), and between greater than 0.0 weight percent to less than about 0.01 weight percent Nitrogen (N). A laser weld interface joins the first steel alloy workpiece to the second steel alloy workpiece.

### INTRODUCTION

The present disclosure relates generally to press-hardened steel components; more specifically to press-hardened steel components formed of two different steel alloys joined by a laser welding process.

In automotive applications, high strength steel alloys are transformed into complex shapes by hot stamping, also referred to as press hardening. Structural parts that require tailored mechanical properties, such as the B-pillar of an automotive body, are manufactured from steel blanks, also known as workpieces, which are cut and trimmed from steel sheets into predetermined shapes and sizes. These workpieces are heated in a furnace at a predetermined temperature and time, hot stamped within a die into a predetermined part configuration, and then quenched to achieve the desired structural properties. High strength steel automotive parts that are manufactured by a press hardening process are known as press hardened steel (PHS) components.

A B-pillar, which is located between the front and rear doors to connect the body of a vehicle to the roof, has two sections. The upper section, with respect to the direction of gravity, is formed of a high strength steel alloy designed to protect passengers against intrusions into the passenger compartment from a side impact. The lower section is formed of a ductile steel alloy designed to absorb impact forces from a side impact. The high strength steel alloy may be joined to the ductile steel alloy by laser welding, which would require that any existing surface coatings, such as AlSi, be removed before the two steel alloys may be joined by laser welding. The removing of the coating is time and labor intensive.

Thus, while existing surface coated steel alloys achieve their intended purpose for obtaining tailored property of B-pillar, there is a need for steel alloys with sufficient surface oxidation resistant that would elimination the need for a surface coating; thus eliminating the process of having to remove the surface coating.

### SUMMARY

According to several aspects, a press-hardened automotive component is disclosed. The press-hardened automotive component includes a first portion formed from a first steel alloy comprising between about 1.0 and 9.0 weight percent Chromium (Cr), and between about 0.5 and 2.0 weight percent Silicon (Si); and a second portion formed from a second steel alloy comprising between about 1.0 and 9.0 weight percent Chromium (Cr); and between about 0.5 and 2.0 weight percent Silicon (Si).

In an additional aspect of the present disclosure, each of the first steel alloy and second steel alloy further includes between greater than 0.0 to about 3.0 weight percent Manganese (Mn).

In another aspect of the present disclosure, the first steel alloy further includes between about 0.2 and 0.45 weight percent Carbon (C); and the second steel alloy further includes between about 0.01 and 0.25 weight percent Carbon (C).

In another aspect of the present disclosure, each of the first steel alloy and the second steel alloy includes between greater than 0.0 weight percent Nitrogen (N) to less than about 0.01 weight percent Nitrogen (N).

In another aspect of the present disclosure, the press-hardened automotive component further includes a laser weld interface joining the first steel alloy workpiece to the second steel alloy workpiece.

In another aspect of the present disclosure, the laser weld interface includes more than 1 weight percent Chromium (Cr).

In another aspect of the present disclosure, the first steel alloy workpiece includes greater than about 95 percent martensite microstructure; and the second steel alloy includes a ferrite and martensite and bainite microstructure.

In another aspect of the present disclosure, the first steel alloy workpiece includes a tensile strength of between about 1500 Mpa to 2000 MPa.

In another aspect of the present disclosure, second steel alloy workpiece includes a tensile strength of greater than about 500 MPa and less than about 1500 MPa.

In another aspect of the present disclosure, the press-hardened automotive component is a B-pillar for a motor vehicle.

According to several aspects, a steel alloy workpiece assembly for a press-hardening process is disclosed. The steel alloy workpiece assembly includes, a first steel alloy workpiece comprising between about 0.2 and 0.45 weight percent Carbon (C), and between about 0.5 and 2.0 weight percent Silicon (Si); and a second steel alloy workpiece comprising between about 0.01 and 0.25 weight percent Carbon (C), and between about 0.5 and 2.0 weight percent Silicon (Si).

In an additional aspect of the present disclosure, the first steel alloy workpiece further includes between greater than 0.0 to about 3.0 weight percent Manganese (Mn); and the second steel alloy workpiece further includes between greater than 0.0 to about 3.0 weight percent Manganese (Mn).

In another aspect of the present disclosure, the first steel alloy workpiece further includes between about 1.0 and 9.0 weight percent Chromium (Cr); and the second steel alloy workpiece further includes between about 1.0 and 9.0 weight percent Chromium (Cr).

In another aspect of the present disclosure, the steel alloy workpiece assembly further includes a laser weld interface joining the first steel alloy workpiece to the second steel alloy workpiece.

In another aspect of the present disclosure, the laser weld interface contains greater than 1 weight percent Chromium (Cr).

According to several aspects, a method of manufacturing a press-hardened steel alloy component. The method includes: (a) providing a first steel alloy sheet comprising between about 0.2 and 0.45 weight percent Carbon (C), between about 0.0 to 3.0 weight percent Manganese (Mn), between about 1.0 and 9.0 weight percent Chromium (Cr), and between about 0.5 and 2.0 weight percent Silicon (Si); (b) providing a second steel alloy sheet comprising between about 0.01 and 0.25 weight percent Carbon (C), between greater than 0.0 to about 3.0 weight percent Manganese (Mn), between about 1.0 and 9.0 weight percent Chromium (Cr), and between about 0.5 and 2.0 weight percent Silicon (Si); (c) cutting the first and second steel alloy sheets to predetermined shapes, so as to obtain a first steel alloy workpiece and a second steel alloy workpiece; (d) assembling the first steel alloy workpiece and the second steel alloy workpiece to form a steel alloy workpiece assembly; (e) welding the first steel alloy workpiece to the second steel alloy workpiece to form a weld interface; (f) heat treating the welded steel alloy workpiece assembly at a predetermined time and temperature; (g) hot stamping the welded steel alloy workpiece assembly into the press-hardened steel alloy component; and (h) quenching the press-hardened steel alloy component at a predetermined quench rate.

In an additional aspect of the present disclosure, step (f) includes heating the steel alloy workpiece assembly at a time and temperature sufficient for the first workpiece to comprise a full austenite microstructure and the second workpiece to comprise a ferrite and austenite microstructure.

In another aspect of the present disclosure, step (h) includes quenching the steel alloy workpiece assembly at a rate of greater than 15° C. per second such that the first workpiece is transformed into a greater than 95 percent martensite structure and the second workpiece is transformed into a ferrite and martensite microstructure.

In another aspect of the present disclosure, the weld interface contains more than 1 weight percent Chromium (Cr).

In another aspect of the present disclosure, step (g) includes hot stamping the welded steel alloy workpiece assembly into a B-pillar for a motor vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic view of a press-hardened steel alloy (PHS) component having a high strength upper portion and a ductile lower portion, according to an exemplary embodiment;

FIG. 2 is a schematic illustration of a process flow of a method for manufacturing the PHS component of FIG. 1, according to an exemplary embodiment;

FIG. 3 is a Temperature vs Time transformation diagram of a heat treating process for manufacturing the PHS component of FIG. 1, according to an exemplary embodiment;

FIG. 4 is a Stress-Strain curve of the PHS component of FIG. 1 compared to a known PHS component, according to an exemplary embodiment;

FIG. 5 is a photograph of a surface of a lab specimen steel alloy having 3 weight percent Chromium (Cr) and 0 weight percent Silicon (Si);

FIG. 6 is a photograph of a surface of a lab specimen steel alloy having 0 weight percent Chromium (Cr) and 1.8 weight percent Silicon (Si); and

FIG. 7 is a photograph of a surface of a lab specimen steel alloy having 3 weight percent Chromium (Cr) and 1.5 weight percent Silicon (Si).

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

The present disclosure provides a press-hardened steel (PHS) component, such as a structural component for a motor vehicle, having multiple portions with tailored mechanical properties that is achieved through a common hot press-hardening process. The present disclosure also provides steel alloy workpieces having a sufficient chromium (Cr) and silicon (Si) content such that multiple steel alloy workpieces may be joined by laser welding to provide a single workpiece, or workpiece assembly 112, having multiple portions with tailored mechanical properties after undergoing a hot press-hardening process. The present disclosure further provides a method of manufacturing a PHS component having multiple portions with tailored mechanical properties. While laser welding is disclosed as an embodiment, it should be appreciated that other welding techniques such as resistant spot welding and brazing may also be utilized.

FIG. 1 shows a press-hardened steel (PHS) structural member, such as a B-pillar 100, of a motor vehicle (not shown). The PHS B-pillar 100 includes an upper portion 102, or first portion 102, formed from a first steel alloy workpiece 104 and a lower portion 106, or second portion 106, formed from a second steel alloy workpiece 108. A mating surface of the upper portion 102 is joined to a mating surface of the lower portion 106 by laser welding forming a laser weld interface 110 before the press-hardening process. The laser weld interface 110 includes a weld seam width of about 1 to 10 mm. The first steel alloy workpiece 104, after press-hardening, provides the upper portion 102 of the B-pillar 100 with a higher strength than the lower portion 106. The second steel alloy workpiece 108, after press-hardening, provides the lower portion 106 with greater ductility as compared to the upper portion 102.

The first steel alloy workpiece 104 and second steel alloy workpiece 108 includes a sufficient weight percent of Chromium (Cr) and Silicon (Si) in order to resist surface oxidation, thus eliminating the need for a surface coating such as Al—Si and an ablation step to remove the coating before joining the first steel alloy workpiece 104 to the second steel alloy workpiece 108 by laser welding. The first steel alloy workpiece 104 includes a composition of between about 0.2 and 0.45 weight percent Carbon (C), between about greater than 0.0 to 3.0 weight percent Manganese (Mn), between about 1.0 and 9.0 weight percent Chromium (Cr), between about 0.5 and 2.0 weight percent Silicon (Si), and greater than 0 but less than 0.01 weight percent Nitrogen (N). The second steel alloy workpiece 108 includes a composition of between about 0.01 and 0.25 weight percent Carbon (C), between about greater than 0.0 to 3.0 weight percent Manganese (Mn), between about 1.0 and 9.0 weight percent Chromium (Cr), between 0.5 and 2.0 weight percent Silicon (Si), and less than 0.006 weight percent Nitrogen (N). Each of the first steel alloy workpiece 104 and second steel alloy workpiece 108 includes less than 0.8 weight percent Molybdenum (Mo), less than 0.005 weight percent Boron (B), less than 0.3 weight percent Niobium (Nb), and less than 0.3 weight percent Vanadium (V).

A summary table of the composition in the first workpiece and second workpiece is provided in Table A.

TABLE A

| | C | Mn | Cr | Si | N | Other elements |
|---|---|---|---|---|---|---|
| Workpiece | (Wt %) | (Wt %) | (Wt %) | (Wt %) | (Wt %) | (Wt %) |
| First | 0.20-0.45 | >0.0-3.0 | 1.0-9.0 | 0.5-2.0 | >0 < 0.01 | Mo < 0.8, B < 0.005, |
| Workpiece | | | | | | Nb < 0.3, V < 0.3 |
| Second | 0.01-0.25 | >0.0-3.0 | 1.0-9.0 | 0.5-2.0 | >0 < 0.01 | Mo < 0.8, B < 0.005, |
| Workpiece | | | | | | Nb < 0.3, V < 0.3 |

The first steel alloy workpiece 104 and the second steel alloy workpiece 108 are assembled and joined by laser welding, so as to obtain a welded steel alloy workpiece assembly 112. The alloy composition of the first steel alloy workpiece 104 and the second steel alloy work piece provides a laser weld interface 110, or laser weld joint 110, having more than 1 weight percent Chromium (Cr). After the welded steel alloy workpiece assembly 112 undergoes hot press-hardening as disclosed below, the first steel alloy workpiece 104 is transformed into an upper portion 102 of the PHS B-pillar 100 and the second steel alloy workpiece 108 is transformed into a lower portion 106 of the PHS B-pillar 100. The upper portion 102 have greater than about 95 percent martensite micro-structure and the lower portion 106 have a ferrite and martensite/bainite micro-structure.

The resulting tensile strength of the upper portion 102 of the PHS B-pillar 100 is between 1500 to 2000 MPa, which is sufficient strength to provide intrusion resistance into the passenger compartment of a motor vehicle from a side impact. The strength of the lower portion 106 of the PHS B-pillar 100 is above 500 MPa but less than 1500 MPa, therefore the lower portion 106 has a lower tensile strength than the upper portion 102. However, the lower portion 106 has higher ductility than the upper portion 102 for the absorption of side impact forces.

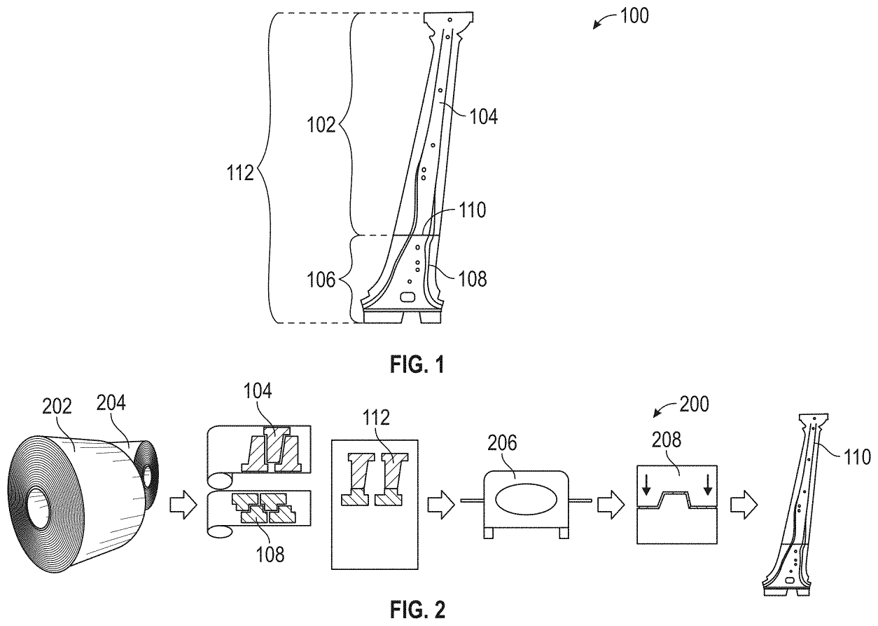

FIG. 2 shows a process flow of a method, generally indicated by reference number 200, of manufacturing a press hardened welded steel alloy workpiece assembly 112 from the first steel alloy workpiece 104 laser welded to the second steel alloy workpiece 108. The method begins by providing a first coiled sheet 202 of a first steel alloy and a second coiled sheet 204 of a second steel alloy; unrolling and cutting the first coiled sheet into a plurality of first steel alloy workpieces 104 having a predetermined size and shape; unrolling and cutting the second coiled sheet into a plurality of second steel alloy workpieces 108 having a predetermined size and shape; assembling and welding the first steel alloy workpiece 104 to the second steel alloy workpiece 108 to form a workpiece assembly 112; heating the workpiece assembly 112 in a furnace 206 at a predetermined time and temperature; hot stamping the workpiece assembly 112 in a die 208 into the PHS component, such as the B-pillar 100; quenching the PHS component at a predetermined quench rate, which may also be executed in the die 208.

The first steel alloy from the first coiled sheet includes an alloy composition as disclosed above for the first steel alloy workpiece 104, and the second steel alloy from the second coiled sheet includes an alloy composition as disclosed above for the second steel alloy workpiece 108. The unique alloy compositions of the first steel alloy and the second steel alloy provide an intrinsic surface oxide film, which eliminates the need for an oxidation resistant coating on the workpieces to protect the workpieces from oxidation before and during the hot pressing process. The elimination for the need of an oxidation resistant coating reduces cost by eliminating need for a surface coating, such as Al—Si, and associated ablation process to remove the coating before welding.

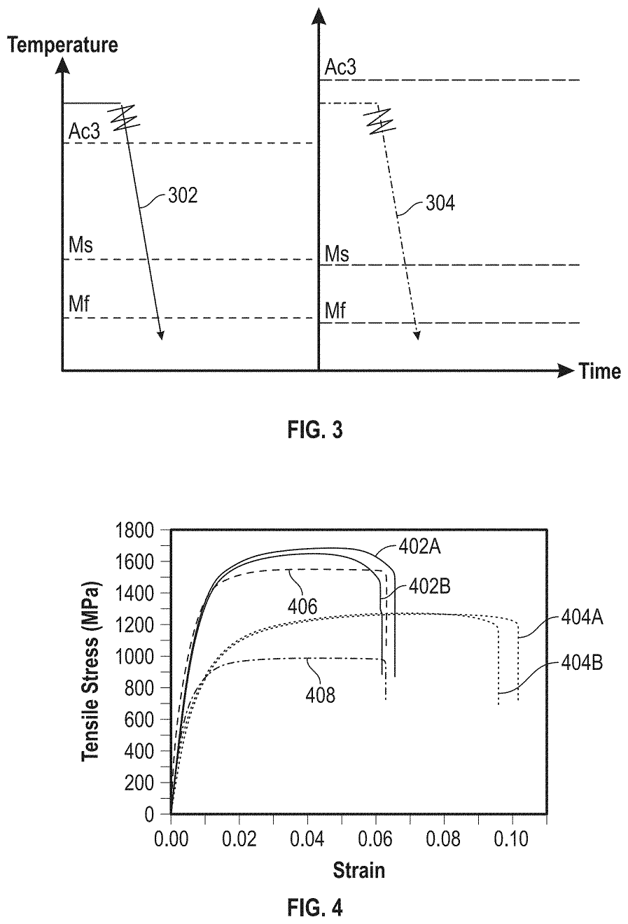

FIG. 3 shows a Time-Temperature transformation diagram of hot stamping process according to an exemplary embodiment is shown. After the first steel alloy workpiece 104 is laser welded to the second steel alloy workpiece 108 forming a workpiece assembly 112, the workpiece assembly 112 is heated in the furnace 206 at a temperature between about 880° C. to 950° C., which is above the austenitic temperature (Ac3) for the first steel alloy workpiece 104 as indicated by curve 302, but below the austenitic temperature (Ac3) of the second steel alloy workpiece 108 as indicated by curve 304. The workpiece assembly 112 is held at that temperate for a length of time and hot stamped such that the first steel alloy workpiece 104 is transformed to have a fully austenite microstructure and the second workpiece is transformed to have a ferrite and austenite microstructure. The workpiece assembly 112 is then quenched at a rate of greater than 15° C. per second such that the first steel alloy workpiece 104 is transformed to have a greater than about 95 percent martensite microstructure and the second workpiece is transformed to have a ferrite and martensite microstructure. The austenite microstructure provides the upper portion 102 with a high strength structure while the ferrite and austenite microstructure provides the lower portion 106 with a ductile structure.

FIG. 4 shows a Stress-Strain comparison of a PHS B-pillar 100 formed of the first steel alloy workpiece 104 (as shown in curves 402a and 402b) and the second steel alloy workpiece 108 (as shown in curves 404a and 404b), as disclosed above, compared to a PHS B-pillar 100 formed of conventional Usibor 1500 steel alloy (as shown in curve 406) and Ductibor 1000 steel alloy (as shown in curve 408). Laboratory result has shown that the high strength upper portion 102 of the PHS B-pillar 100 has higher strength compared to Usibor 1500, and the high ductility lower portion 106 of the PHS B-pillar 100 has better ductility compared to Ductibor 1000. The welded steel alloy workpiece assembly 112 improves the performance for intrusion resistance and energy absorption.

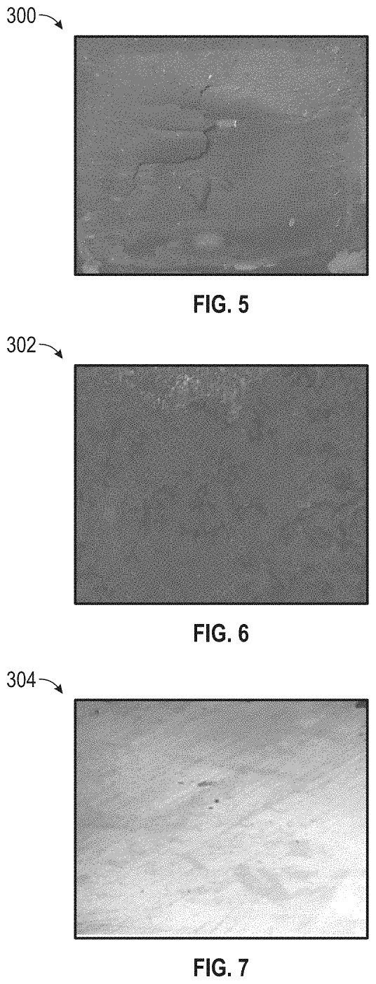

FIG. 5 is a photograph of a surface of a lab specimen steel alloy 300 having 3 weight percent Chromium (Cr) and 0 weight percent Silicon (Si). FIG. 6 is a photograph of a surface of a lab specimen steel alloy 302 having 0 weight percent Chromium (Cr) and 1.8 weight percent Silicon (Si). FIG. 7 is a photograph of a surface of a lab specimen steel alloy 304 having 3 weight percent Chromium (Cr) and 1.5 weight percent Silicon (Si).

Each of the lab specimen steel alloys 300, 302, 304 is heat in an oven at 900° C. for 10 minutes and followed by air-cooling to room temperature. Each of lab specimen steel alloys 300, 302 exhibit substantial surface oxidation as indicated by the darker coloring. The lab specimen steel alloy exhibits superior surface oxidation resistance, as evidence by the lack of a dark discoloration, as compared to specimen steel alloys 300, 302. FIGS. 5, 6, and 7 clearly shows that that a steel alloy having 3 weight percent Chromium (Cr) and 1.5 weight percent Silicon (Si) exhibits superior surface oxidation resistance to steel alloys having either Chromium (Cr) or Silicon (Si) separately when subjected to heat treatment at 900° C. for 10 minutes and followed by air-cooling to room temperature.

The above disclosure provides for steel alloys that are advantages for manufacturing a press-hardened welded steel alloy component. The disclosed compositions provide thin surface oxide films for welded steel alloy component contacting atmosphere directly. The above disclosure also provides a method of manufacturing such a welded steel alloy component with tailored mechanical properties and the method would reduce cost by elimination coating need and associated weld process for removal.

Numerical data have been presented herein in a range format. “The term “about” as used herein is known by those skilled in the art. Alternatively, the term “about” includes +/−0.05% by weight”. It is to be understood that this range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. While examples have been described in detail, those familiar with the art to which this disclosure relates will recognize various alternative designs and examples for practicing the disclosed method within the scope of the appended claims.

While the invention has been described in connection with one or more embodiments, it should be understood that the invention is not limited to those embodiments. On the contrary, the invention covers all alternatives, modifications and equivalents as may be included within the spirit and scope of the appended claims.

What is claimed is:

1. A press-hardened automotive component, comprising,
a first portion formed from a first steel alloy comprising between about 1.0 and 9.0 weight percent Chromium (Cr), and between about 0.5 and 2.0 weight percent Silicon (Si); and
a second portion formed from a second steel alloy comprising between about 1.0 and 9.0 weight percent Chromium (Cr), and between about 0.5 and 2.0 weight percent Silicon (Si).

2. The press-hardened automotive component of claim 1, wherein each of the first steel alloy and the second steel alloy further comprises between greater than 0.0 to about 3.0 weight percent Manganese (Mn).

3. The press-hardened automotive component of claim 2, wherein:
the first steel alloy further comprises between about 0.2 and 0.45 weight percent Carbon (C); and
the second steel alloy further comprises between about 0.01 and 0.25 weight percent Carbon (C).

4. The press-hardened automotive component of claim 3, wherein each of the first steel alloy and the second steel alloy comprises between greater than 0.0 weight percent to less than about 0.01 weight percent Nitrogen (N).

5. The press-hardened automotive component of claim 4, further comprising a laser weld interface joining the first steel alloy to the second steel alloy.

6. The press-hardened automotive component of claim 5, wherein the laser weld interface comprises more than 1 weight percent Chromium (Cr).

7. The press-hardened automotive component of claim 4, wherein:
the first steel alloy comprises greater than about 95 percent martensite microstructure; and
the second steel alloy comprises a ferrite and martensite and bainite microstructure.

8. The press-hardened automotive component of claim 7, wherein the first steel alloy comprises a tensile strength of between about 1500 MPa to 2000 MPa.

9. The press-hardened automotive component of claim 8, wherein the second steel alloy comprises a tensile strength of greater than about 500 MPa and less than about 1500 MPa.

10. The press-hardened automotive component of claim 9 is a B-pillar for a motor vehicle.

11. A steel alloy workpiece assembly for a press-hardening process, comprising:
a first steel alloy workpiece comprising between about 0.2 and 0.45 weight percent Carbon (C), and between about 0.5 and 2.0 weight percent Silicon (Si); and
a second steel alloy workpiece comprising between about 0.01 and 0.25 weight percent Carbon (C), and between about 0.5 and 2.0 weight percent Silicon (Si).

12. The steel alloy workpiece assembly of claim 11, wherein:
the first steel alloy workpiece further comprises between greater than 0.0 to about 3.0 weight percent Manganese (Mn); and
the second steel alloy workpiece further comprises between greater than 0.0 to about 3.0 weight percent Manganese (Mn).

13. The steel alloy workpiece assembly of claim 12, wherein:
the first steel alloy workpiece further comprises between about 1.0 and 9.0 weight percent Chromium (Cr); and
the second steel alloy workpiece further comprises between about 1.0 and 9.0 weight percent Chromium (Cr).

14. The steel alloy workpiece assembly of claim 13, further comprising a laser weld interface joining the first steel alloy workpiece to the second steel alloy workpiece.

15. The steel alloy workpiece assembly of claim 14, wherein the laser weld interface contains greater than 1 weight percent Chromium (Cr).

16. A method of manufacturing a press-hardened steel alloy component, comprising:
(a) providing a first steel alloy sheet comprising between about 0.2 and 0.45 weight percent Carbon (C), between greater than 0.0 to about 3.0 weight percent Manganese (Mn), between about 1.0 and 9.0 weight percent Chromium (Cr), between about 0.5 and 2.0 weight percent Silicon (Si);
(b) providing a second steel alloy sheet comprising between about 0.01 and 0.25 weight percent Carbon (C), between about 0.0 to 3.0 weight percent Manganese (Mn), between about 1.0 and 9.0 weight percent Chromium (Cr), between about 0.5 and 2.0 weight percent Silicon (Si);
(c) cutting the first and second steel alloy sheets to predetermined shapes, so as to obtain a first steel alloy workpiece and a second steel alloy workpiece;
(d) assembling the first steel alloy workpiece and the second steel alloy workpiece to form a steel alloy workpiece assembly;
(e) welding the first steel alloy workpiece to the second steel alloy workpiece to form a weld interface;
(f) heat treating the welded steel alloy workpiece assembly at a predetermined time and temperature;
(g) hot stamping the welded steel alloy workpiece assembly into the press-hardened steel alloy component; and
(h) quenching the press-hardened steel alloy component at a predetermined quench rate.

17. The method of claim 16, wherein the step (f) includes heating the steel alloy workpiece assembly at a time and a temperature sufficient for the first workpiece to comprise a full austenite microstructure and the second workpiece to comprise a ferrite and austenite microstructure.

18. The method of claim 17, where the step (h) includes quenching the steel alloy workpiece assembly at a rate of greater than 15° C. per second such that the first workpiece is transformed into a microstructure with at least 95% martensite and the second workpiece is transformed into a ferrite and martensite microstructure.

19. The method of claim 8, wherein the weld interface comprises more than 1 weight percent Chromium (Cr).

20. The method of claim 19, where step (g) includes hot stamping the welded steel alloy workpiece assembly into a B-pillar for a motor vehicle.
